(19) United States
(12) Patent Application Publication
(10) Pub. No.: US 2024/0042882 A1
(43) Pub. Date: Feb. 8, 2024

(54) METHOD OF FAST CHARGING ELECTRIC VEHICLES

(71) Applicant: Zero Electric Vehicles Corp., Mesa, AZ (US)

(72) Inventors: James L. Maury, Mesa, AZ (US); Damon Kuhn, Needville, TX (US)

(21) Appl. No.: 18/221,993

(22) Filed: Jul. 14, 2023

Related U.S. Application Data
(60) Provisional application No. 63/474,036, filed on Jul. 14, 2022.

(51) Int. Cl. B60L 53/62; H02J 7/00; B60L 53/16; B60L 53/18

(52) U.S. Cl. CPC B60L 53/62; H02J 7/0045; H02J 7/0013; B60L 53/16; B60L 53/18; H02J 7/0029; B60L 2240/547

(57) ABSTRACT

A system and method for fast charging batteries of an electric vehicle are disclosed. A battery charging system includes a charge cable for connection to a source of electrical power and a charge controller. The charge controller includes a detector for detecting a format of the power supply by the source of electrical power, and a battery management system for conforming the power supplied to the power required. The battery management system is configured to direct power to selected ones of a plurality of battery modules, and regulate charging to the selected battery modules.

### CROSS-REFERENCE TO RELATED APPLICATION

This application claims the benefit of and priority to U.S. Provisional Patent Application Ser. No. 63/474,036, filed on Jul. 14, 2022, the contents of which are hereby incorporated by reference in its entirety.

### TECHNICAL FIELD

The present disclosure relates to electric vehicles and an improved system for recharging the batteries carried by electric vehicles, particularly in areas where traditional electric vehicle charging stations are not readily available.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some of the primary barriers to electric vehicle (EV) adoption are range anxiety (fear of totally discharging batteries and becoming stranded along the side of the road), need for multi-hour recharges and charge station cost (and consequently a lack of availability) of faster chargers. The fear of becoming stranded arises due to the lack of an adequate number of recharge stations along routes that drivers may wish to take to reach their desired destinations. Due to the lack of a dense network of recharge stations, drivers are rightfully concerned about their vehicles ability to reach the next available recharge location, posing the risk of running the batteries down to the point where they will not be able to reach the next available recharge station. Another concern about making long trips in electric vehicles is that, if a battery recharge is necessary along the route, and if a recharge station is available, a significant delay can be expected. While drivers of vehicles with internal combustion engines are accustomed to delays associated with refilling a fuel tank, these refills generally require no more than a few minutes. However, recharging a fully discharged electric vehicle can require much longer, sometimes several hours (and in some cases—overnight) for a full recharge. Even with recharge stations available at, for instance, parking lots and retail outlets, recharge times are frequently over an hour even with their versions of high speed commercial recharger systems. For the fastest recharging systems, recharge times of less than half an hour have been reported, but these fast recharge systems are not readily available. Most drivers find it unacceptable to plan on long stops for battery recharges along a multi-hour driving trip and this potential issue is another impediment to adoption of electric vehicles. These charge station limitations (e.g., lack of availability and unacceptably long recharge times) are somewhat co-dependent and are ultimately based on infrastructure cost.

During the summer of 2021, the cost of a single fast charge station was estimated to be approximately $57,600 USD which is an impediment to widespread development of new charge stations. This high cost economically precludes independent gas stations from adding electric charge stations and even large filling station owner/operators cannot justify the high cost in regions where there is limited electric vehicle traffic. As a result, there are fewer electric charge stations than needed to provide consumer confidence in their vehicle's ability to reach the next available charge station along an intended route. In many areas of the US there are highway stretches with no fast recharge facilities available across long distances, and in some cases the distance between charging stations is greater than the rated travelling range of many electric vehicles. Making matters worse, most EVs do not actually achieve driving ranges that match the advertised vehicle range and often the discrepancy is unpredictable. Thus, a combination of factors cause apprehension about use of electric vehicles for longer trips.

Recharging of EVs has evolved over the past few years, commencing with LEVEL 1 and LEVEL 2 charging, and moving largely to high voltage DC (sometimes referred to as LEVEL 3 or direct current fast charging (DCFC”) charging in recent times. Generally, LEVEL 1 charging relies on a 120 vac power source while LEVEL 2 charging relies on a 240 vac power source. These approaches often require many hours (sometimes more than 10 hours) for a complete battery recharge. LEVEL 3 (commonly referred to as fast charging or DCFC) provides a higher voltage DC power source, with significantly greater power delivery capabilities facilitating vehicle recharge typically in less than 30 minutes and sometimes in less than 15 minutes. It is the scarcity of these fast chargers that lead to consumer apprehension in driving EVs for longer trips. If recharge times of over an hour might be required during a trip, most of the time the trip would be judged not feasible for the electric vehicle due to the expected delays associated with the recharge.

The current approach to resolving this consumer apprehension is to develop longer range vehicles with the same or longer ranges than comparable gasoline or diesel internal combustion engine (ICE) vehicles. However, with limited availability of charging stations in many areas, range anxiety may still be an issue regardless of stated vehicle range. Further, the extension of vehicle range does not address the high cost of adding new electric charge stations and thus does not address their unavailability at many existing service stations and for long stretches of lightly travelled roads.

For at least these reasons, there is a desire for an improved system and method for fast charging a battery of an electric vehicle.

### SUMMARY

A system and method for fast charging batteries of electric vehicles (EVs) are contemplated. The battery charging system employs a smart cable or adaptor thereof and/or an on-board circuit, as disclosed herein.

According to an aspect, a battery charging system includes a charge cable for connection to a source of electrical power and a charge controller. The charge controller includes a detector for detecting a format of the power supply by the source of electrical power, and a battery management system for conforming the power supplied to the power required. The battery management system is configured to direct power to selected ones of a plurality of battery modules, and regulate charging to the selected battery modules.

According to another aspect, a battery charging system includes a power cord for directing power to a power input port of the EV. The power cord has a plurality of individually selectable interface protocols for connection to a selected power outlet. A current capacity indicator is provided for generating a signal indicative of the rated current capacity of said selected power outlet. A charge controller is configured to control power to the battery pack as a function of the indicated rated current capacity of said selected power outlet, and direct power to the plurality of battery modules as a function of the determined rated current capacity of said selected power outlet.

The present disclosure addresses the availability and economic feasibility of battery charge locations rather than addressing modifying electric vehicles so they will have a longer driving range. The disclosure allows use of readily available AC outlet power, such as normally available 120 VAC or 240 VAC power, to charge the electric vehicle's batteries rather than requiring dedicated, special purpose EV charge stations for battery recharges. A standard 120 VAC or 240 VAC outlet each has a conventional plug configuration relying on conventional outlets, and the vehicle is fit with a compatible cord for plugging into these standard outlets. The power cord is routed to an on-board electronic control module that converts the 120 VAC or 240 VAC line voltage to a suitable DC voltage for charging the vehicle's batteries. Similarly, other standardized electrical outlets such as 440 VAC or higher could be readily employed for vehicle charging without the need for dedicated recharge stations.

To overcome the range anxiety and to facilitate feasible use of EVs for longer road trips, to the present disclosure utilizes a battery charging system including an on-board circuit, retrofitted into EVs so they can accept a fast charge from any suitable electricity source, without the need for accessing a LEVEL 3 charger station, to efficiently charge battery cells or modules. Further, any available LEVEL 1, LEVEL 2 and LEVEL 3 charging can still be utilized. This flexibility will provide greatly improved utility for electric vehicles. The battery charging system may further include a smart cable to facilitate improves and efficiencies in the charge rate of battery cells. The smart cable may be provided with a suitable plug (or plug adaptor) for connection to any number of available electrical outlets. The plug or plug adaptor may include a signal sensor/generator for determining/detecting the format of the power (e.g., current capacity, volts, amps, AC/DC type), which then transmits a signal indicative of the current capacity of the outlet to which the cable is connected. Thus, the smart cable or respectively the plug adapter accounts for different power outlets which may have different voltages and different current capacities. Pursuant to an implementation, a simple approach that does not require the driver to carry an array of charge cords for the various electrical outlet configurations is preferred.

There have been systems made available for allowing EVs to connect to different voltages, such as was common for LEVEL 1 and LEVEL 2 charging options. A separate charge cord was needed for each outlet configuration and a dedicated power module was included in the vehicle to handle the distinct input voltages. Further, a heavy (in automotive terms) transformer was employed to permit conversion of the input voltages to the vehicle's desired DC voltage—typically 12, 36 or 48 volts. As EVs have evolved, their operating voltages have increased, now routinely to levels of 400 volts or higher. With this technical change, it has become commonplace for LEVEL 3 charge facilities to offer charge voltages that are also close to the vehicle operating voltage—perhaps as much as 400 volts or higher. Thus, when the charge station's charge voltage source matches the battery pack voltage, voltage conversions are not necessary. Unfortunately, things are not so simple. There are various voltage levels available at LEVEL 3 charge stations (recently reported to be as high as 1200 volts) and it has become necessary for a vehicle to be able to accept a charge from a charger that may not have the same voltage as the vehicle's battery pack. One approach to this challenge is disclosed in U.S. Pat. No. 10,369,896 that discloses a configuration for an EV wherein a vehicle, upon connection to the dedicated LEVEL 3 charge station, is in communication with the charge station to ascertain the DC charge voltage available for fast charging of the EV. This is an example of a technology that addresses the inconsistencies among various DC charge outlets, but it does not address issues associated with charging from AC sources. This also does not address the fundamental problem of unavailability of a dedicated charge station since the patent's disclosure is directed to differences existing within existing DC charge stations. The unavailability of a suitable charge station remains an unmet need for fast charging of electric vehicles.

The present disclosure permits connection to either fast or slow chargers, as well as connection to any available electrical outlet. This includes both DC and AC power sources, independent of the voltage levels of the power sources. According to implementations of the present disclosure, it is possible to convert the incoming electrical power to suitable voltages utilizing an on-board power converter and to employ already-existing types of battery charge control electronics for regulating the battery charging operations, such as limiting the charging to specified maximum charging rates, complying with upper and lower voltage levels, monitoring battery temperature and adjusting charge currents as needed for temperature stability, setting safety features for other on-board electronics to avoid harmful voltage spikes, etc., for charging the batteries. Moreover, according to further implementations of the present disclosure, in addition to accommodating DC input voltages for battery recharging, there is included additional simple and inexpensive electronics within each vehicle where a power cord can be plugged into any common household outlet (or garage, commercial building, etc.) such as 125 VAC, or 250 VAC, or even 480 VAC to charge the batteries in an electric vehicle. To further improve the new charging arrangement, the system includes circuitry for automatically detecting the operating parameters of the power supply and for implementing appropriate on-board connections to individual portions of the battery pack to optimize charging of the vehicle batteries in a manner that is compatible with the specifications of the power outlet(s) to which the charge system is connected. By providing circuitry that can direct selected levels of charging power (voltage and current being individually controllable) to selected portions of the battery pack, optimized charge power can be directed to specific battery cells, battery modules and the overall battery pack in an optimized manner.

An objective of the present disclosure is to provide a battery charging system for an electrically powered motor vehicle (EV) that can be plugged directly into an available power outlet of standard configuration without the need for an expensive power charging station.

A further objective is to facilitate rapid charging of a motor vehicle by incorporating a vehicle charging system on-board the vehicle that can use an available high voltage 3-phase power supply outlet without the requirement for an intermediate charging station.

Another objective of the disclosure is to allow an on-board vehicle charging system to be connected to various alternative power supply outlets and to charge the vehicle at the highest charge rate compatible with the rated current of the power outlet without the need for the driver to manually set up control parameters for the charging operation.

Yet another objective of the present disclosure is to provide a system for charging the batteries of an electrically powered motor vehicle through connection to a standard 440 volt AC power outlet.

A further objective of the present disclosure is to reduce the need for expensive fast vehicle charge stations and to thereby reduce the impediment to EV adoption.

Another objective of the present disclosure is to facilitate rapid charging of on-board batteries through selective provision of power to individual battery cells or sets of cells for rapid charging and to defer charging of other cells or sets of cells for efficiently utilizing the available charge power and optimizing overall battery recharge time.

These objectives are addressed by providing an on-board circuit (charge controller) that employs inexpensive electronics such as rectifiers and thyristors to control voltage and to then rely on optimized/improved battery charge control circuitry to regulate charge current to individual battery cells or sets/subsets of battery cells. Battery cells/modules may also be separated into proper sets and subsets to align charging voltages with easily produced charge voltage levels, based on incoming voltage supplies. Overall charge current can be matched to outlet rated capacity and there will not be a need for expensive fast charge stations, thereby reducing the impediment to widespread EV adoption associated with range anxiety.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

While the claims are not limited to a specific illustration, an appreciation of the various aspects is best gained through a discussion of various examples thereof. Although the drawings represent illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows.

FIG. 1 is an illustration of a battery charge control circuit in accordance with one embodiment of the invention.

FIG. 2 is an illustration of a power cord and adapter in accordance with another aspect of the invention.

FIG. 3 is an illustration of another implementation of the plug adapter aspect of the invention.

FIG. 4 is an illustration of a circuit suitable for implementation of another aspect of the invention.

FIG. 5 illustrates a circuit arrangement suitable for implementing one embodiment of the invention.

FIG. 6 illustrates another circuit arrangement suitable for implementing another embodiment of the invention.

FIG. 7 illustrates a flow chart of an exemplary method/process for fast charging battery cells of an EV pursuant to an implementation.

FIG. 8 illustrates a flow chart of an exemplary method/process for fast charging battery cells of an EV pursuant to a further implementation.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they do not limit the present disclosure to these embodiments and/or examples. On the contrary, the present disclosure covers alternatives, modifications, and equivalents.

Charging of an electric vehicle is implemented by first providing a source of electricity. The source of electricity, and hence electrical power, for purposes of this description, is an electrical outlet (receptacle) into which a power cord can be plugged. The outlet could be the outlet from a dedicated power charging station for electric vehicles, such as is becoming available at a growing number of locations throughout the network of roadways. These power outlets are generally DC outlets and provide a DC voltage specified at the charging station. Typical DC output voltages at these charging stations have been steadily rising and have been proposed for voltages of 480 DC and higher. Additionally or alternatively, the vehicle can be charged from a readily available AC electrical outlet, such as a conventional 120 or 240 volt AC outlet. These are the outlets such as might be available in a typical household garage or on the outside of a residential building. Typical electric vehicle chargers based on these residential 120 VAC outlets (LEVEL 1 charging) can typically charge a vehicle at rates within the range of 3.5 to 6.5 miles of range per hour while LEVEL 2 chargers based on a 220 VAC outlet can charge a vehicle at a rate of about 14 to 35 miles of range per hour. In further implementation, a higher voltage power outlet can provide greater charging rates so that if a 440 volt AC power outlet can be utilized, charge rates can exceed 140 miles of range per hour. However, since the objective of the present disclosure is to provide flexibility to the operator of an electric vehicle, it is preferable to provide for the fastest available charging. There will be situations where a fast charger is not available, so the ability to employ the best available power supply is important, as is the ability to get the fastest available charge from the available power supply. Thus, for the greatest utility, the system and method provided in accordance with the present disclosure is compatible with either AC or DC power sources and can accommodate a range of voltage and power levels.

Pursuant to an implementation, a 3-phase 440 volt electrical outlet provides a connection point for obtaining electrical power from the grid. A typical 440 VAC outlet configuration rated for a 30 amp current is employed (for instance NEMA L16-30) and a standard mating plug for this L16-30 connector is provided on the power cord for the vehicle. At the other end of the power cord, the vehicle power cord attaches to the vehicle via a standard vehicle charge plug configuration. A common vehicle connection interface is known as the ‘J Plug” and conforms to any of the implementations of SAE J1772. Another common configuration is the Type 2 CCS.

This plug configuration does not have pins that are well suited for a three phase input, so a variation of the connector is needed. There have been variations proposed, and it would be feasible to use a J Plug variation for connecting to the 440 VAC 3-phase line.

For purposes of the present disclosure, it might be preferable to use a more recent (and still evolving) standard connection interface such as specified in IEC 62196-2 (type 3). Recognizing that use of a standard interface is likely to be the most commercially acceptable, and that use of a standard interface is commercially preferred, adaptation of one of these standards for handling of a three-phase signal (presumably by either reallocating the function of pins within the connector, or by adding additional pins to supplement the standard interface). However, to take the greatest advantage of the disclosure, an interface design that is optimized to accept direct line voltage will provide the greatest technical advantage. This can be done by adding a supplemental electrical interface to the vehicle input port, the supplemental interface being adapted to receive single- or three-phase line voltages. For purposes of this description, it will be assumed that the power input to the vehicle is either direct line voltage (an AC voltage) or the output from a charge station (generally a DC voltage). The direct line voltage can be connected to the supplemental interface and the output from a charge station can be connected to the standard interface such as the J Plug. The supplemental interface, according to an example, is integrated with the power cord such that the vehicle need not be modified, and the standard vehicle charge receptacle is employed without modification.

Thus, for a residential outlet, the vehicle charge cable will directly connect to either 120 or 240 VAC, and for the preferred implementation, the vehicle will directly connect to 440 VAC and as a supplementary feature of the system according to the disclosure, acceptance of preconditioned electrical power from a charge station, typically a DC voltage, can be accommodated.

The power input to the vehicle is connected to a sensor circuit that is employed for determining the input voltage. Based on the input voltage, charge power will be routed/allocated according to a variable charge protocol as disclosed herein. The charging of individual battery modules/cells will be controlled by a battery charge controller, or battery control system/module, that also includes typical charge control features such as overcurrent protection, shorting protection, overheat protection, high and low voltage protection, etc. These protective circuits are sometimes also referred to as Battery Monitoring Devices (BMD), but the function of interest here is the same—protection of the vehicle and the batteries during charging.

A power or battery management control circuit is provided for battery management during charging, to conform to power supplied to the power required. The present disclosure may utilize existing battery management technology for general charging implementation. Additional features of this embodiment include a detector for receipt of an input characterization signal provided by the smart cable system for indicating the rated current capacity of the outlet to which the cable is connected.

The smart cable includes a signal generator (could be active or passive) for indicating the current capacity of the outlet to which the cable is connected. In this manner, the battery management system can provide charge to the battery system up to but not exceeding the rated current capacity of the outlet. This feature protects the supply system rather than the vehicle and prevents blowing of fuses or tripping of circuit protection mechanisms in the electrical supply system. This is an important, and not previously addressed, consideration in the charging of electric vehicles. For one manner of implementation of the signal generation indicative of the rated current capacity of the supply outlet, the charge cable includes a signal generator and is thus referred to herein as a smart cable.

The smart cable may have the capacity to include a splitter for connection to a plurality of power outlets for purpose of combining the total power available.

The smart cable can have either individual plugs (each with the signal generation feature) or one or more adapters fitted with signal generator features for providing a signal indicative of the current capacity of the outlet. Outlet capacity is indicated at the outlet based on the outlet configuration, where different current capacity outlets have individual physical structures. Thus, when a 480 v outlet is single phase, the outlet configuration differs from a 480 v three-phase outlet configuration. Similarly, when the outlet is 480 v with a 40 amp current capacity, the outlet configuration differs from a 480 v outlet with a 60 amp current capacity. At the receiving end, on the vehicle, it is known to detect the voltage, and to take appropriate steps to configure the charging appropriately. However, where rapid charging is highly valuable, the added ability to draw the full available current at the provided voltage aids in meeting the commercial objective of rapid charging. This allows confidence in drawing current at the provided voltage, taking advantage of the highest current that can be drawn from the outlet consistent with the current rating of the outlet.

The smart cable may have a signal generator (digital signal, small resistor, capacitor, impedance device, coded signal (e.g., a radio frequency identification (RFID) tag) consistent with the general desire of having a low energy signal that signifies the current capacity of the outlet as indicated by the configuration of the outlet, when the outlet complies with standard configuration specifications. Dedicated cables for each configuration are less desired, so an adapter plug (or preferably a set of adapter plugs) can be provided with individual current capacity signal generators for each of the multiple connection alternatives. In an exemplary arrangement, a single adapter is configured to contain multiple plug configurations each having a given current capacity, for example each of a 110 v, a 220 v and a 480 v plug rated for 15 amps. A single signal generator may be provided for this adapter, signifying that the current being supplied should be drawn at no greater that the 15 amp rated current level. Another adapter may be provided for 20 amp service at a plurality of supply voltages, such as 120 v, 240 v and 480 v. Again, a single signal generator may be provided for this adapter to signify the 20 amp rating. When an adapter is provided to take advantage of only the most frequently provided voltage and current combinations, individual signal generators may be provided for each plug, indicative of the rated current capacity supplied to each individual plug. Then, whichever plug is employed, a proper current rating signal may be provided through the cable. With this information, the battery charge controller can provide charge current to the battery system at the highest current possible, consistent with the rated current capacity of the outlet. For example, a single adapter might interface with a 15 amp 120 volt outlet, a 20 amp 220 volt outlet, a 50 amp 220 volt outlet, and a 100 amp 440 volt three-phase outlet, and the ability to generate current indicating signals for each of the distinct rated current levels.

The signal, when received at the charger control system, also actuates a suitable configuration of internal switches (e.g., as part of the battery management circuit) for routing the desired voltage and current to specific portions of the battery system, whether that be to individual cells, to sets of cells, or to the overall battery pack.

The smart cable mates with the vehicle at the vehicle's existing power input port and is desirably configured as a standard charge cable configuration (e.g., a 3-phase 480 v power cable). This allows the vehicle to have only one power inlet, eliminating the need for extra hardware. The signal indicative of current rating can be transmitted as a high frequency signal on one of the power or ground leads for the charge cable. This signal can be detected on-board using readily available signal receivers.

The signal could alternatively be transmitted wirelessly to the vehicle directly from the adapter. When any individual adapter input is energized through connection to charge power, a signal may be transmitted to the receiver on-board. For this feature, a radio frequency (RF) transmission could be implemented using any desired coding technique. Examples of readily available coding techniques might include using the tire pressure monitoring system (TPMS) and encoding current capacity information into the signal protocol used for TPMS. This has the advantage of making use of already-existing RF reception equipment present on the vehicle and thus avoids the need for any incremental hardware at the vehicle end. Similarly, use of any other existing receiver on the vehicle would be equally advantageous. Another option would be to use a dedicated receiver for the signal having an indication of the current rating of the outlet.

A short delay in ramping up charge current will allow time for the current capacity signal to be received and processed. Less than one (1) second is needed for this purpose so there is no significant delay in vehicle charging. It is feasible to have the current capacity signal decoded in parallel with the input voltage evaluation so that there is no incremental delay in commencing vehicle charging.

From a general perspective, this aspect of the disclosure is operative to allow optimized battery charging. To facilitate efficient charging of the battery cells, the on-board control module provides suitable voltage and current to selected battery cells according to a charge algorithm that is tailored to the number of battery cells selected for charging and the power capacity of the available outlet. Providing a custom plug arrangement allows for a standard interface to be employed at the vehicle and for a variable interface to be employed at the outlet. By having interchangeable plugs at the outlet end of the charge cord, a single cord can be carried in the vehicle along with a universal interface adapter (or an adapter set) capable of mating with a variety of widely available outlet configurations. Thus, if an outlet is a 120 VAC outlet, a sensor in the electronics will detect the voltage and the electronic control module will initiate a suitable voltage conversion to the desired DC charging voltage for the battery cells. Since there is a typical current capacity for 120 VAC outlets (typically 15 amps even though there are 20 amp circuits used for 120 volts) this known limitation to 15 amps can be taken into consideration and tripping of a circuit breaker can be avoided. Similarly, if the line voltage is 240 VAC, the electronics will make the appropriate voltage conversions. However, simply adjusting the voltage does not take advantage of the full range of existing protocols in consumer outlets. Different current capacity outlets have different standardized plug configurations. For instance, a 240 VAC outlet rated for 30 amps is available with a NEMA configuration NEMA 6-30 while a 240 VAC outlet rated for 50 amps is available with a NEMA configuration NEMA 6-50. By providing a smart connector arrangement, the selected plug can provide an indication to the control module indicative of the current capacity of the outlet, allowing utilization of the full available outlet power and still avoiding tripping of circuit breakers. There are other relatively high voltages used, such as the 400-480 v configurations that are the most common now, with NEMA L8-30, NEMA L16-30 and NEMA L19-30R being examples of available configurations for 480 VAC interconnects. An example of a plug configuration suitable for implementation according to the disclosure would be a three-way adapter having each of a NEMA L8-30, NEMA L16-30 and NEMA L19-30R plug. A single code could be generated in the smart cable (or within the adapter) and provided to the charge controller indicating that the rated current capacity of the incoming power is 30 amps. Then, the charge control circuitry could draw upon the full 30 amps without concern for exceeding the rated current of the outlet.

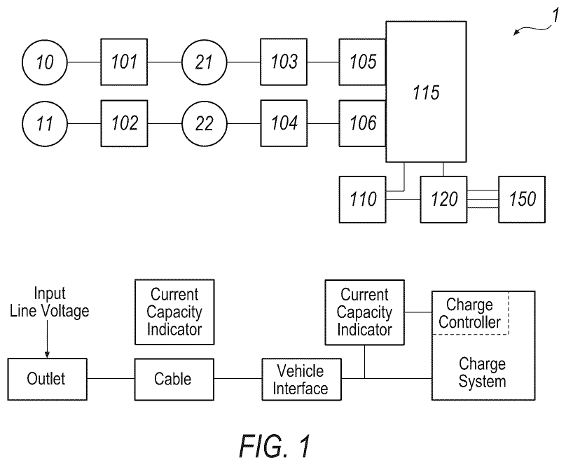

Turning now to FIG. 1, an exemplary battery charging system 1 is shown. The system 1 can be implemented using one or more power cables, and for convenience in describing the implementation, this example illustrates an embodiment having two power cables. The system 1 includes power first and second cables 21, 22 each including, at a first end, a respective plug configuration 101, 102 compatible with a standard electrical outlet 10, 11. In this example, first outlet 10 is a 20 amp 220 Volt standard outlet and second outlet 11 is a traditional 50 amp 440 Volt three-phase outlet. First plug 101 on first cable 21 is a typical 20 amp male plug compatible with the first outlet 10. Second plug 102 on second cable 22 is a conventional 440 Volt three-phase male plug compatible with second outlet 11. Each of first and second cables 21 and 22 have a vehicle connection terminal at its second end for connection to the vehicle at a vehicle charge port 105, 106. Preferably, each cable 21,22 has a standard J-Plug for connection to the vehicle and the vehicle is equipped with one or more receptacles 105, 106 for the J-Plugs. First cable 21 is provided with a (first) signal generator 103 for providing a signal indicative of the current capacity of the electrical outlet into which the cable is plugged. Thus, signal generator 103 would provide a signal indicating that 20 amps are available through first cable 21. This indication is predetermined based on the physical configuration of first plug 101 that is specifically designed to interface with a 20 amp 220 Volt electrical outlet. In similar fashion, second plug 102 is specifically configured to interface with a 50 amp 440 Volt three-phase electrical outlet. As a result, (second) signal generator 104 provides a signal indicating that 50 amps are available through second cable 22.

One or more on-board sense or autosense or sensor circuits 115 (current capacity receiver) receive signals generated by first and second signal generators 103, 104 and provide information to battery management circuit or system 110 for regulation of the total battery charge power provided to power converter(s) 120, which direct power to selected battery modules 150. The battery management system 110 may be configured to direct power to one or more of a plurality of battery modules, and regulate charging to selected ones of the plurality of battery modules. That is to say, the battery management system 110 allocates power to individual battery cells and/or sets/subsets of battery cells in a manner that optimizes charging time. With this signal generated from cables 21 or 22 via signal generators 103, the battery management system 110 can utilize the full current available from the charge cable without blowing fuses or tripping circuit protection mechanisms.

Pursuant to implementations, the battery management system 110 allocates power to selected ones or all of the battery modules in accordance with a format of the power detected by a detector (e.g., autosense circuit 115) of the charge controller. The format (e.g., current capacity) of the power includes voltage, and/or AC or DC current, and/or rated amperage, which may be communicated by the signal generator 103, 104.

The plugs 101, 102 may each comprise a cable interface adapter coupled to the charge cable that includes a sensor configured to detect the format of the power to determine which of a plurality of interfaces is selectively connected to power, and provide a signal (e.g., via signal generator 103, 104) to the charge controller (e.g., via receiver(s) and autosense circuit) for use in regulating the power allocated to the battery modules or cells. The signal may indicate the rated current capacity of the selected interface.

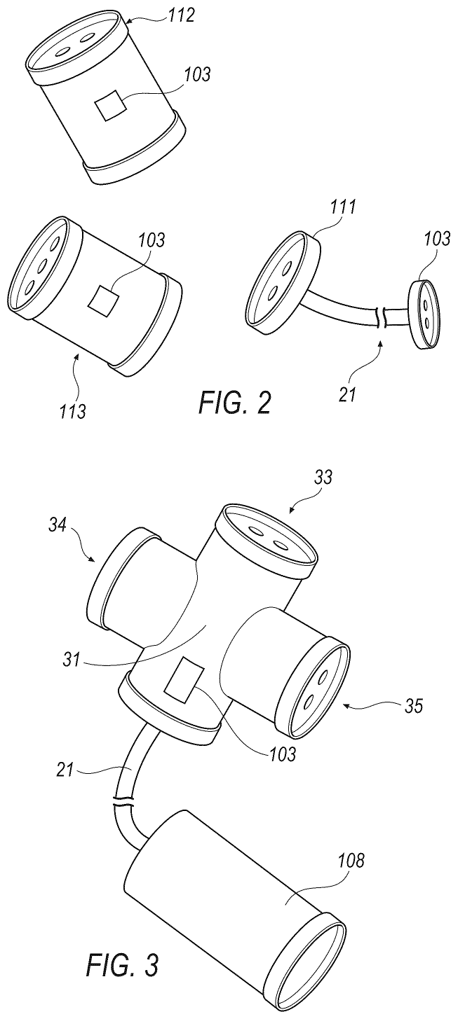

In a typical charge configuration, only one cable would be employed. However, due to the standard interface 101, 102 to the standard vehicle interface 105, 106, it is possible to switch cables and to use the appropriate cable to mate with the available power supply. FIG. 2 illustrates an alternative implementation where a single cable 21 has a standard J-Plug 103 for connection to the standard vehicle charge interface port 105 (shown in FIG. 1). The other end of cable 21 has a universal connector 111 designed for connection to interchangeable mating connectors 112, 113. In this implementation, connector 112 mates with a 220 volt 30 amp outlet and fits into connector 111 to cause the cable 21 to connect from the 220 volt outlet to the vehicle. A signal generator 103 associated with connector 112 indicates that the outlet is rated for 30 amps. This signal is provided to the vehicle sensor circuit for regulation of the charge system. Standard connector 113 is designed to interface with the 440 Volt 50 amp standard outlet. As with connector 112, connector 113 includes the interface for standard connector 111 at the end of charge cable 21. By securing connector 113 into socket 111 the charge cable 21 allows connection from the 440 Volt three phase outlet directly to the vehicle interface plug 105. Signal generator 113 provides a signal indicating that the outlet is rated for 50 amps, allowing the charge control circuitry to utilize up to this level of current.

FIG. 3 illustrates another exemplary configuration pursuant to an implementation. Cable 21 has a conventional J plug 108 at a first end and has a multi plug pin array 31 at its other end. Four separate plug formats 32, 33, 34 and 35 are provided in the multi plug array 31. In a preferred embodiment, each of the plug configurations in plug array 31 are distinct from the others and each mates with a commonly available outlet configuration. Generation of a signal indicative of the current capacity of the outlet is provided by a current rating signal generator 103. If all of the outlet configurations provided on the multi plug array 31 have the same current rating, a single current indication signal can be generated without concern for which of the connection plugs is engaged in an outlet. However, if the plugs do not all have the same current rating, multiple different signals can be generated to provide a signal corresponding to the current rating of the plug that is plugged into the outlet. This can be accomplished by having distinct signal generators associated with each plug. Alternatively, the signal can be generated by a single signal generator that includes sufficient logic to provide the distinct signals representative of the distinct current capacity ratings of the separate outlets to which the cable might be connected. Then, when any particular plug is engaged, the signal will correspond with the current capacity of the outlet that mates with the selected plug. Plug configuration standards may be predefined in the current rating signal generator 103 to help determine the distinct signals of different types of plugs.

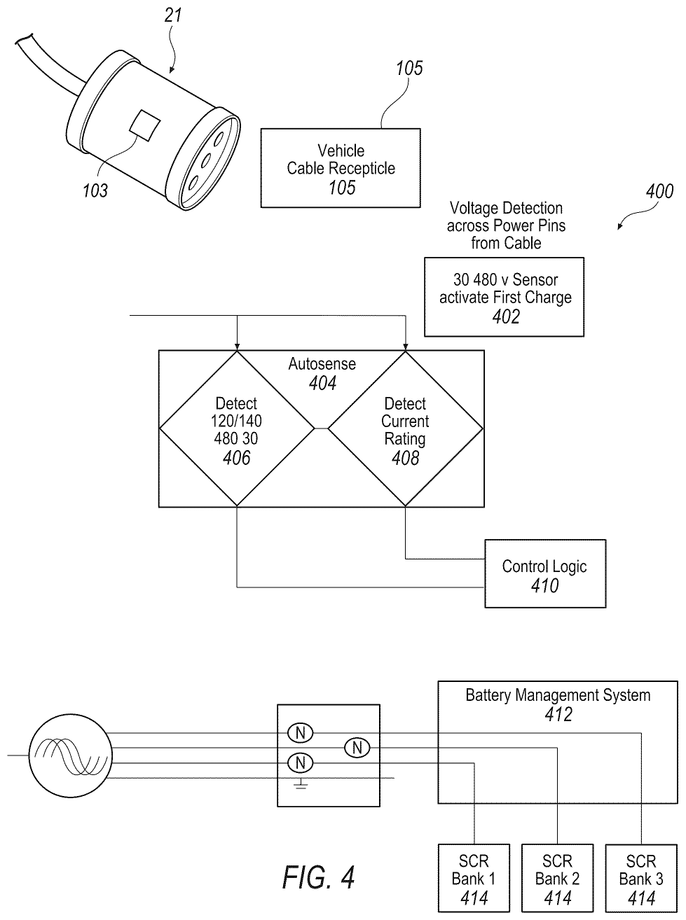

FIG. 4 illustrates an on-board circuit 400 (e.g., a charge controller) suitable for implementation of another aspect of the disclosure. The on-board circuit may be retrofitted or otherwise incorporated into the EV. The signal power leads from the external power cord 21 are connected to the charging system through the vehicle's power interface 105. When the power cord 21 is connected to either a standard 120 volt or 220 volt outlet, the cable operates in typical fashion for LEVEL 1 or LEVEL 2 charging and may include an adapter with a signal generator 103. The on-board logic system determines the input voltage, e.g., via signals received from the signal generator 103 and/or via a current capacity indicator/detector 402 (e.g., sensor), and routes the power to the charge control circuitry (e.g., voltage converters to convert the input voltage to a predetermined charge voltage for the battery cells to be charged). The autosense circuit 404 detects both the voltage 406 and the rated current 408 for the outlet from which the power is supplied, and from the smart power cord 21, and provides (through control logic 410 such as a processor) appropriate power via battery management system 412 to charge the battery cells or modules 414 according to the battery charge portion of the battery management system. The provision of thyristors (silicon controlled rectifiers (SCRs)) 416 provide rectified and regulated power to the selected battery cells/modules 414, pursuant to techniques/processes disclosed herein. Each of the thyristors 416 are associated with one or more battery cells 414. Pursuant to an implementation, each thyristor 416 is associated with a subset of battery cells of the battery back, so that the control logic 410 and battery management system 412 can implement the methods for fast charging as disclosed herein, e.g., variable allocation of charge power to the battery cells 414 to optimize charge rate.

According to one aspect, when a 480 volt 3-phase outlet is available, the smart power cord 21 can plug directly into the 480 volt outlet and four (4) leads within the power cord 21 can be utilized for the 3-phase power. The autosense circuitry 404 senses the voltage on the input power leads and senses the signal provided from the smart charge cable 21 to regulate the battery charging system (e.g., via BMS 412 and thyristors 416), allowing for use of the full available charge power, voltage and current.

In a typical implementation of Level 1 and Level 2 charging, an on-board transformer is employed in the conversion of the charge voltage to a voltage compatible with providing charge to the batteries. Typically, an ac/dc converter has been employed and is of a type that includes a transformer on board the vehicle. For charging from DCFC systems, the transformer is not needed, but is still present on the vehicle. In a typical prior implementation, dc-dc voltage converters were used to match the available charge power to the battery system. This is performed within the battery management system 412 under the control of the battery charge system.

According to another aspect of the disclosure, the transformer can be omitted from the vehicle, reducing weight and thus adding to the overall energy efficiency of the vehicle. As shown in FIG. 4, the signals from the battery management system 412 can be converted to the desired voltage level for charging of the batteries.

With the disclosed smart cord 21 for direct supply of line voltage to the vehicle input port and switches for isolating sets and subsets of cells for optimized charging, any vehicle port can accept either of line voltage (single or triple phase) or charge station voltage dc.

Another aspect of the disclosure involves a 480 v 3-phase implementation, including all of the features in the cable as well as the features in the vehicle, e.g., so that a 3-phase 480 v power cable can be coupled a power source and connected to the vehicle. This embodiment manages each current branch separately so the full capacity of the outlet (power source) can be captured efficiently. There is nothing special required at the outlet—just a regular outlet—with appropriate outlet configuration characterization and generation of a signal (e.g., via signal generator 103) to signify the current capacity of the outlet.

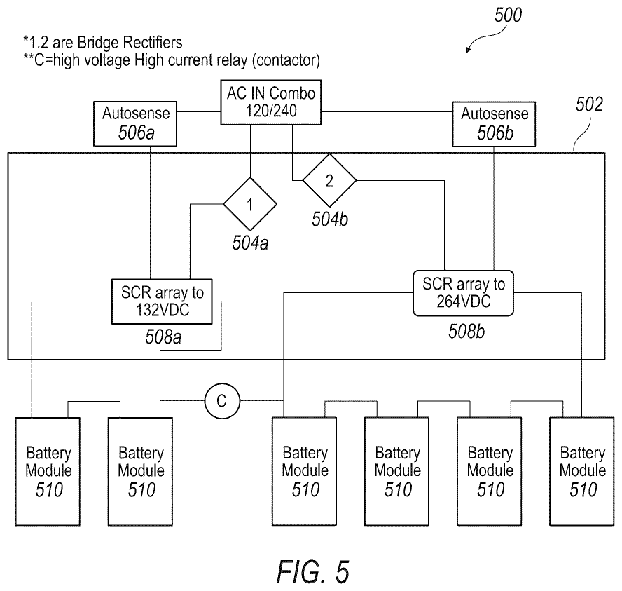

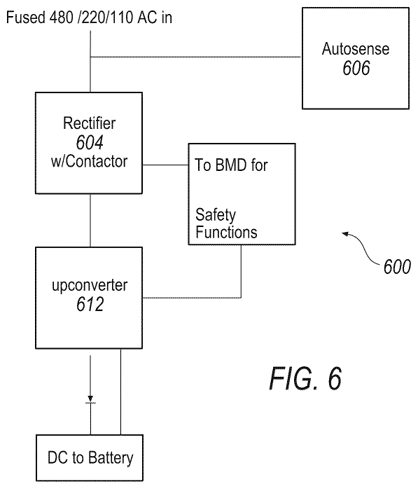

As shown in FIGS. 5 and 6, there is shown an implementation of the on-board circuitry 500, 600 in a very cost effective manner through the use of a contactor C (HV switch) controlled by the already existing and required battery management system or device (BMS or BMD, respectively) 502, 602 for safety controls (overvolt, overtempt, shorting, etc.) to power a high amp rectifier 504a, 50b, 604 made of readily available diodes. That would also be controlled by low voltage autosense 506a, 506b, 606 and current limiting circuits and have a one leg output diode to prevent current reversal. Silicon controlled rectifiers (SCRs) or thyristors 508a, 508b pass the charge current to the battery cells or modules 510.

The systems 500, 600 provide for a roughly 80-100 kw charge circuit which conceivably would allow a 50% charge in a time frame of only a few minutes. This would also allow the oil companies/gas stations to simply install 480 v three-phase power for chargers thereby eliminating most of the infrastructure issues.

With a smart cable to charge an EV having the on-board circuitry to convert to DC, it is possible to separate the battery modules 510 on board the vehicle into divisors of the available voltage to facilitate a small, lightweight, relatively inexpensive on board AC to DC charge circuit.

In the example presented in FIGS. 5 and 6, the battery modules 510 can use a 66 VDC charge for optimum battery life/charge rate. Specifically, for the implementation of FIG. 6, it is desirable to utilize 480 VAC 3-phase line voltage and to use the BMD 602 for safety functions and to control contactor pre-rectifier for safety cutoff if needed. It is also desirable to use an up-converter 612 for 110/220 volt home charging.

With reference to FIG. 5, rectified and regulated 240 AC is processed through an array of thyristors (silicon controlled rectifiers (SCRs)) 508a, 508b to provide the needed 264 VDC for four (4) of the battery modules 510 in series. A separate 120 VAC leg is used in the same manner to provide the 132 VDC for the other two battery modules 510 (e.g., rectified and regulated 120 AC is processed through thyristors 508a, 508b to provide the 132 VDC to the two battery modules 510). A special cable may be provided, either by the user or potentially at the charge point to provide the needed ac hookup, and a switch (contactor C) may be provided to actuate a high voltage, high current between the bank of four battery modules and the bank of two battery modules. This contactor C may be used to break the normal series connection between the modules 510 while charging. Also included would be an autosense circuit 506a, 506b to monitor voltage and connect to the BMS 502 for safety control—in the event of a fault. Additionally or alternatively, the incoming connector may have a (second) contactor triggered by the BMS system 502 to shut down power to the circuit.

In this example, three 240 VAC inputs may be used to power two “power stations”. The premise could be used in many different configurations to charge different voltage EV's. Aside from the cost of a special cable and the on-board electronics, all that would be necessary is any number of readily available 240 VAC drops with proper connections. The required investment to have a “charge point” using this method is miniscule compared to current methods and could possibly also be turned into an “uber” charging network by homeowners/small businesses due to the common nature of the requirements and low capital requirements.

According to the disclosure, simple and inexpensive electronics may be retrofitted or otherwise incorporated into vehicle with already existing complicated electronics necessary for required charging rates, upper and lower voltage levels, temperature stability, safety features, etc., for charging the batteries, where it can be plugged into any common household outlet (or garage, commercial building, etc.) such as 125 VAC, or 250 VAC, or even 480 VAC to charge the batteries in all electric vehicles, which outlet power is automatically detectable and switchable through the smart cable. These power sources are simply converted into high voltage/high current DC sources on-board each vehicle thereby eliminating the infrastructure need of expensive charging stations.

The present disclosure addresses the availability of battery charge locations rather than addressing modifying electric vehicles so they will have a longer driving range. The disclosure allows use of readily available AC outlet power, such as normally available 120 VAC or 240 VAC power, to charge EV batteries rather than requiring dedicated, special purpose EV charge stations for battery recharges. A standard 120 VAC or 240 VAC outlet each has a conventional plug configuration relying on conventional outlets, and the vehicle is fit with a compatible cord for plugging into these standard outlets. The power cord is routed to an on-board electronic control module that converts the 120 VAC or 240 VAC line voltage to a suitable DC voltage for charging the vehicle's batteries. Similarly, other standardized electrical outlets such as for 400 VAC or higher could be readily employed for vehicle charging without the need for dedicated recharge stations.

The basic idea revolves around the current cost of EV fast chargers as related to EV adoption. The concept is to have an on-board circuit comprising a rectifier and thyristors to control voltage. Battery modules would be separated into proper numbers to match incoming voltage from existing 220V infrastructure while charging—there will need to be nothing more than 220 VAC outlets such as those used for household appliances (e.g., a dryer). The provision of a special cable onsite or carried by the owner would be required for the connection.

This implementation can utilize different voltages on the separate power outlets to take advantage of the greatest available range of power sources for a quick charge. The use of voltage converters associated with the individual input ports can accommodate the specific voltage available at each port. FIG. 1 illustrates the separate input sources 10,11 that are connected to the sense circuits 115. The battery management system 110 and power converters 120 convert the voltages on the separate inputs as needed for proper power provision to the battery system.

One embodiment of the disclosure includes a power generation station for use in providing electrical power to a charge input port of an electric vehicle having a plurality of outlets, each separately circuit protected and having a rated current capacity. This embodiment takes advantage of existing standard outlet configurations consistent with voltage and rated current capacity. To provide for efficient voltage and current management on the vehicle, there is a charge cable with a plurality of power inlet interfaces compatible with a plurality of said power outlets, suitable for parallel connection to a user-selected plurality of said power outlets to provide additive power capacity higher than the capacity of any one of said selected power outlets to optimize power supplied to said vehicle.

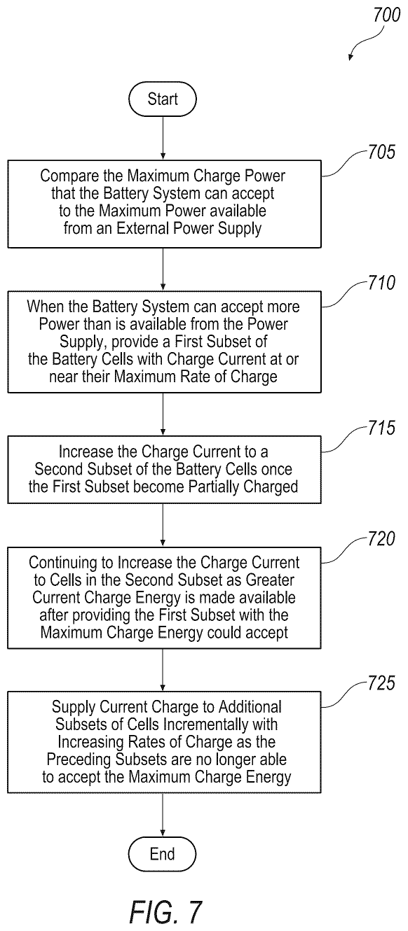

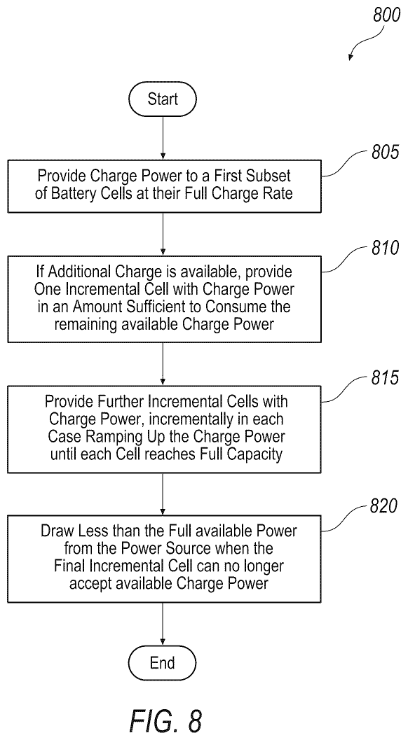

With reference to FIG. 7, a flow chart of an exemplary method/process for fast charging batteries or battery cells is shown. There is a power curve for each cell, specifying the current that can be supplied as a function of the state of charge. Overall charging time can be optimized by calculating the available power source's voltage and current limit and then selecting fewer than all of the cells for an initial fast charge, and tapering the current supplied to each cell as a function of its characteristics, adding new cells at full current as partially charged cells accept lesser current, thus allowing full utilization of available charge current for the longest possible time. In addition to the state of charge, the temperature of the battery module influences the rate at which charge can be accepted. Thus, control of the charge current is additionally a function of battery module temperature. Still further, the temperature of the module is influenced by the addition of energy into the module. The predicted module temperature is also considered in the calculation of the amount of charge current, all calculated to permit the vehicle to accept the full available charge current for the longest possible time before tapering off due to the batteries approaching full charge. In implementing this desirable charge protocol, to the method includes comparing the maximum charge power that the battery system (e.g., a plurality of battery cells or modules) can accept to the maximum power available from the external power supply at step 705. When it is determined that the battery system can accept more power than is available from the power supply, a first subset of the battery cells can be initially provided with charge current at or near their maximum possible rate of charge while other cells are not initially provided with their maximum charge current at step 710. Then, as the cells in the first subset become partially charged (e.g., charged beyond a threshold charge), they will no longer be able to accept as much charge current. At step 715, the charge current to be supplied to a second subset of the battery cells is increased, while still providing the first subset with the maximum charge current that they can accept. Then, at step 720, the cells in the second subset will have their charge current increased as greater charge energy is available after providing the first subset with the maximum charge energy that they can accept. At step 725, additional subsets of cells can incrementally be provided with increasing rates of charge as the preceding subsets are no longer able to accept the full/maximum available charge power. In this manner, the full available power can be employed for a longer period of time than would be available by simply providing equal charge to all of the cells in parallel from the beginning.

With reference to FIG. 8, a flow chart of an exemplary method/process for fast charging batteries or battery cells is shown pursuant to a further implementation. At step 805, charge power is provided to a first subset of the cells within the battery system at their full charge rate, such that the full charge rate at which these cells can accept charge is provided each of the cells in the first subset of cells. If any additional charge power is available, one incremental cell is provided with charge power in an amount sufficient to absorb/consume the remaining available charge power at step 810. As the cells being charged become more charged, and as their rate of charge diminishes, incremental cells are provided with charge power, one at a time, in each case ramping up the charge power until each incremental cell reaches its capacity to accept faster charge power at step 815. At that point, the next cell is provided with charge power until all cells are accepting charge at their capacity. Eventually, when the final cell can no longer accept the available charge power, the battery system will start to draw less than the full available power from the power source at step 820. With this approach, the full power available will be used for the longest possible period of time, providing the battery system with the greatest amount of energy possible within this time period. After all cells are accepting charge at their capacity, only then does the system draw less than the available current from the power supply.

The temperature of the battery modules can be regulated through the use of phase change materials surrounding the cells. Allowing the phase change materials to reach, and then exceed, optimum charge temps will allow radiation of more heat while other cells are accepting charge at maximum rates. Thus, employing phase change materials can further optimize the system capability of accepting the full available charge current for the longest possible time, taking into consideration the varying state of charge of each module and the actual and projected temperature of each module.

The simplicity of the invention will be greatly appreciated in implementing widely available power supply locations for charging electric vehicles without the need for building a widespread network of expensive dedicated vehicle charging stations.

While the invention has been described with respect to several specific implementations, it is to be understood that the innovation includes many other possible implementations based on the inventive concepts as described herein.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that a computer, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

An electronic controller and/or an electronic processor may include a programmable microprocessor and/or microcontroller, such as an application specific integrated circuit (ASIC). The controller may include or communicate with a memory (e.g., a non-transitory computer-readable storage medium, and/or an input/output (I/O) interface. The controller may be configured to perform various functions, including those described in greater detail herein, with appropriate programming instructions and/or code embodied in software, hardware, and/or other medium.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A battery charging system for use in charging of an electric vehicle comprising a battery pack having a plurality of battery modules, a battery protection circuit, a battery controller and a battery charge port having a charge port interface, the battery charging system comprising:
a charge cable for connection to a source of electrical power;
a charge controller comprising:
a detector for detecting a format of the power supplied by the source of electrical power;
a battery management circuit for conforming the power supplied to the power required, regarding the power and the voltage needed on a module basis of the plurality of battery modules;
the battery management circuit configured to direct power to selected ones of the plurality of power modules, and to regulate charging to said modules.

2. The battery charging system of claim 1, wherein the format of the power includes at least one of voltage, alternating current (AC) or direct current (DC) power, and rated amperage.

3. The battery charging system of claim 1, wherein the charge cable includes a signal generator for providing a signal indicative of a current capacity of the power.

4. The battery charging system of claim 1, further comprising a cable interface adapter coupled to the charge cable, the cable interface adapter including a sensor configured to detect which of a plurality of interfaces is selectively connected to power and providing a signal to the charge controller, via the charge cable, for use in regulating the power allocated to the battery modules.

5. The battery charging system of claim 4, wherein said signal indicates rated current capacity of a power outlet.

6. The battery charging system of claim 4, wherein said selectable interfaces include a first interface for a power outlet rated for not more than 15 amps at 125 VAC and a second power outlet rated for not less than 30 amps at 400 VAC or higher.

7. The battery charging system of claim 4, wherein said selectable interfaces include at least one of a third interface for a 3-phase power outlet rated for at least 208 VAC, a fourth interface for a 3-phase power outlet rated for at least 400 VAC, and a fifth interface for a 3-phase power outlet rated for at least 480 VAC.

8. A battery charging system for an electric vehicle of the type having a battery pack comprising a plurality of battery modules, a battery controller and a power input port, said battery charging system comprising:
a power cord for directing power to said power input port, said power cord having a plurality of individually selectable interface protocols for connection to a selected power outlet;
a current capacity indicator for generating a signal indicative of the rated current capacity of said selected power outlet;
a charge controller configured to control power to the battery pack as a function of the indicated rated current capacity of said selected power outlet, and direct power to the plurality of battery modules as a function of the determined rated current capacity of said selected power outlet.

9. The battery charging system of claim 8, wherein the charge controller regulates power to individual battery modules of the plurality of battery modules.

10. The battery charging system of claim 8, wherein the charge controller regulates power to subsets of the plurality of battery modules.

11. The battery charging system of claim 8, wherein the current capacity indicator is provided on an adapter plug of the power cord.

12. The battery charging system of claim 8, wherein the selectable interfaces include a first interface for a power outlet rated for not more than 15 amps at 125 VAC and a second power outlet rated for not less than 30 amps at 400 VAC or higher.

13. The battery charging system of claim 8, wherein the charge controller is configured to initially allocate power to a first subset of the plurality of battery modules but not a second subset of the plurality of battery modules.

14. The battery charging system of claim 13, wherein the charge controller is configured to direct power to the second subset once the first subset is charged to a threshold charge.

15. The battery charging system of claim 13, wherein the charge controller is configured to provide power to the first subset at their full charge rate, and then direct power to one incremental module in the second subset in an amount sufficient to consume a remaining available charge power from the first subset.

16. The battery charging system of claim 8, wherein the charge controller directs power to the plurality of battery modules via a battery management system including a plurality of thyristors.

17. The battery charging system of claim 8, wherein the power cord includes an interface adapter having a sensor to detect which of the plurality of selectable interface protocols is selectively connected to power and providing the signal via the current capacity indicator to a current capacity receiver coupled to the charge controller for use in regulating the power directed to the plurality of battery modules.

18. A method of fast charging battery cells of a battery pack for an electric vehicle, comprising:
comparing a maximum charge power that the batty pack can accept to a maximum power available from an external power supply;
providing a first subset of the plurality of battery cells with charge current at their maximum possible charge rate while not providing a second subset of the plurality of battery cells their maximum possible charge rate; and
increasing the charge current to the second subset once the battery cells in the first subset are charged beyond a threshold charge.

19. The method of claim 18, wherein increasing the charge current to the second subset is performed while the first subset is still charged the maximum possible charge rate.

20. The method of claim 18, further comprising incrementally charging additional subsets of battery cells with increasing rates of charge as the preceding subsets of battery cells are no longer able to accept the maximum charge power.
